(19) United States
(12) Patent Application Publication
(10) Pub. No.: US 2026/0298510 A1
(43) Pub. Date: Oct. 1, 2026

(54) Portable Cooling Device

(71) Applicant: Michael Allen Buckman, Nespelem, WA (US)

(72) Inventor: Michael Allen Buckman, Nespelem, WA (US)

(21) Appl. No.: 19/704,943

(22) Filed: Jun. 11, 2026

Related U.S. Application Data
(63) Continuation-in-part of application No. 19/096,109, filed on Mar. 31, 2025.
Application No. 19/096,109 is a continuation-in-part of application No. 18/308,361, filed on Apr. 27, 2023, now Pat. No. 12,569,014.
(60) Provisional application No. 63/337,022, filed on Apr. 29, 2022.

(51) Int. Cl. F25B 21/02; A41D 13/005; A42B 1/008; G01K 3/00

(52) U.S. Cl. CPC F25B 21/02; A41D 13/0053; A42B 1/008; G01K 3/005

(57) ABSTRACT

A portable system for cooling which includes a Peltier thermoelectric cooler coupled to the garment and utilitarian apparatuses, including wheelchairs, automobiles, child carriers, and military equipment. The thermoelectric cooler comprises a cold side plate and a hot side plate. The cooling device further comprises a thermal shield. The thermal shield comprises a thermally reflective surface and a thermal conduction sheet coupled to the cold side of the thermoelectric cooler. The portable cooling device further comprises a cold pack thermally coupled to a side of the thermal conduction sheet. The portable cooling device comprises a blower configured to blow air across the hot side of the thermoelectric cooler.

### FIELD OF THE INVENTION

The present invention relates generally to a portable device for cooling, in particular a portable device for cooling that is integrated into a wearable garment or carrying device.

### BACKGROUND OF THE INVENTION

In many instances, a user may have to complete tasks or endure inclement weather conditions. For instances where the conditions are extremely hot, the wearer may have limited options to protect themselves from the ambient heat and protect their skin from ultraviolet radiation. For example, in extreme heat, a person may have to remove clothing to release internal heat to cool themselves off. Removing those layers of clothing can expose skin, potentially causing exposure to sunburn or ultraviolet radiation. Conversely, adding those layers reduce skin exposure but can raise the temperature and discomfort for the wearer. Accordingly, there is a need for a portable cooling device that can be integrated into a garment while also providing the wearer with the ability to manage the temperature control.

### SUMMARY OF THE INVENTION

One objective of the present invention is to provide a portable device for cooling that is integrated into a wearable garment or carrying device. The device can include a garment having a wearer-facing side and a rear facing side. The device can include a thermoelectric cooler. The thermoelectric cooler can be coupled to the garment. The thermoelectric cooler can comprise a cold side plate and a hot side plate. The cold side plate can be oriented to be proximate to the body of the wearer. The hot side plate can be oriented between the cold side plate and ambient environment. The cooling device can further comprise a thermal shield. The thermal shield can define an opening wherein the cold side of the thermoelectric cooler is exposed. The thermal shield can comprise a thermally reflective surface that faces the wearer-facing side of the garment. The device can comprise a thermal conduction sheet coupled to the cold side of the thermoelectric cooler. The thermal conduction sheet can also be positioned between the thermal shield and the wearer-facing side of the garment. The device can also comprise a cold pack thermally coupled to a side of the thermal conduction sheet opposite the side of the thermal conduction sheet that is coupled to the cold side of the thermoelectric cooler. The device can comprise a blower coupled to the garment and located adjacent to the hot side of the thermoelectric cooler. The blower can be configured to blow air generated by the hot side of the thermoelectric cooler and away from the garment. The device can also include a power source configured to power the thermoelectric cooler and the blower.

### BRIEF DESCRIPTION OF THE DRAWINGS

FIG. 1 is a diagram of the present invention.

FIG. 2 is a diagram of an alternate embodiment of the present invention.

FIG. 3 is a chart of the plurality of plates of the present invention.

FIG. 4 is a chart of the electrical energy supply of the present invention.

FIG. 5 is a chart of the thermal shield of the present invention.

FIG. 6 is a chart of the thermally reflective surface of the present invention.

FIG. 7 is a chart of the second (supplemental) thermal shield of the present invention.

FIG. 8 is a chart of the removable cold pack of the present invention.

FIG. 9 is a chart of the polyimide heating component of the present invention.

FIG. 10 is a circuit diagram of the present invention.

FIG. 11 is a diagram of the circuit, power source, controller, and user interface of the present invention.

FIG. 12 is an alternative diagram of the present invention.

FIG. 13 is a chart of the embodiments of the attachments of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of a portable cooling device, embodiments of the present disclosure are not limited to use only in this context.

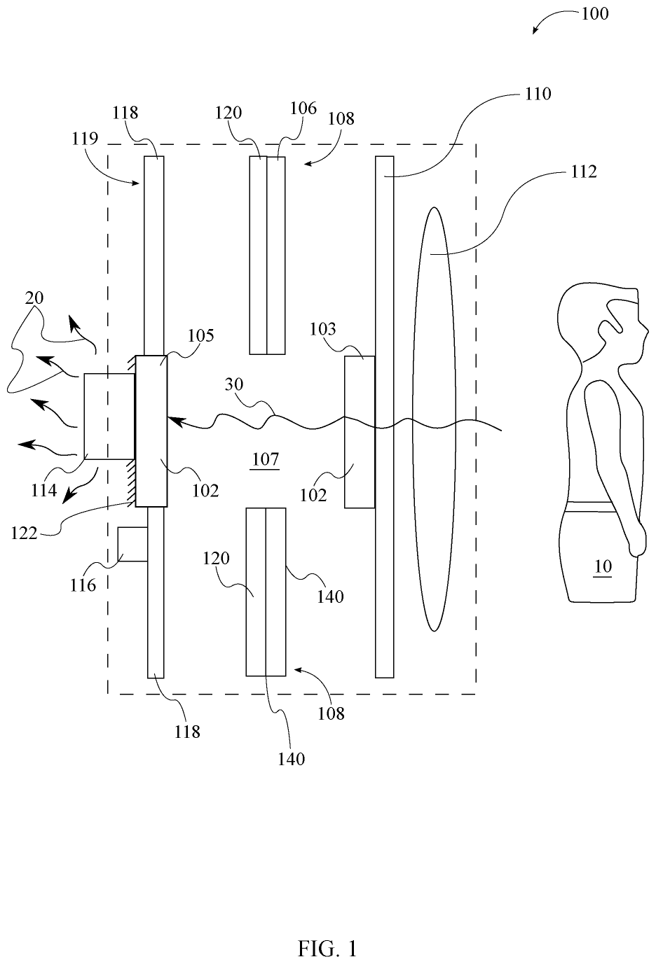

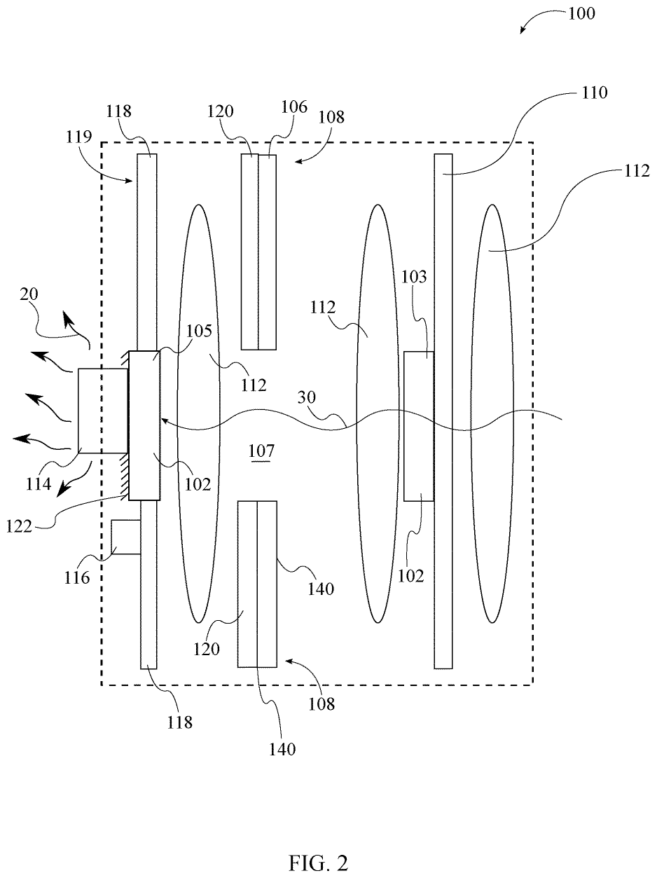

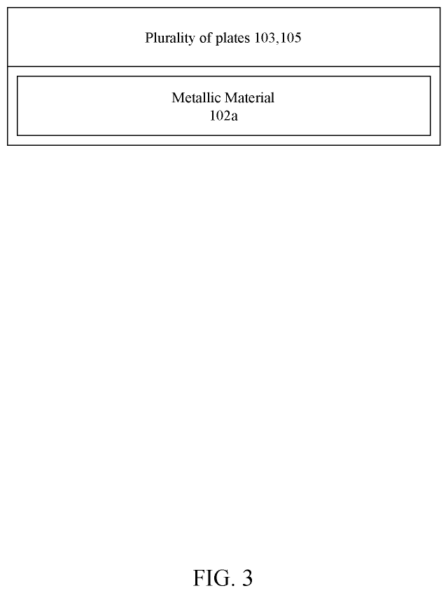

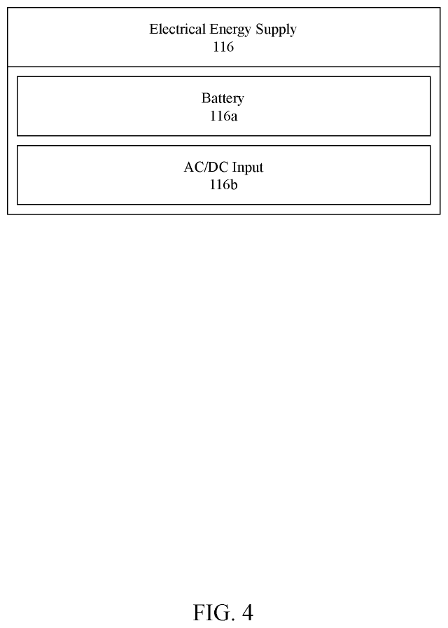

As shown in FIG. 1 and FIG. 2, in the preferred embodiment of the present invention, the portable cooling device 100 comprises a plurality of layers. The plurality of layers of the portable cooling device 100, in the preferred embodiment, are configured to facilitate heat transfer from a wearer 10, while enabling the wearer 10 to control the temperature and rate of heat transfer from the garment. In one embodiment of the present invention, the plurality of layers is composed of a material, wherein said layers of material are coupled with fasteners. In the preferred embodiment of the present invention, the material comprises a windproof material. In alternative embodiments of the present invention, the material comprises a waterproof material. In an embodiment wherein the material comprises a waterproof material, said material is a material that is not water permeable. In embodiments wherein the material comprises a windproof material, said material is not permeable by airflow from an exterior source, for example wind. In the preferred embodiment of the present invention, the fasteners comprise mechanical fasteners including screws. In alternative embodiments of the present invention, the plurality of layers of material are chemically bonded together. In the preferred embodiment of the present invention, the cooling device 100 comprises a thermoelectric cooler 102. The thermoelectric cooler 102 of the present invention, in some embodiments, is a thermoelectric cooling device 100 that utilizes the Peltier effect to transfer heat throughout the system. In one embodiment of the present invention, the thermoelectric cooler 102 comprises a plurality of plates 103, 105. In the preferred embodiment of the present invention, the thermoelectric cooler 102 comprises two plates 103, 105 composed of a metallic material 102a, as shown in FIG. 3. In said embodiment, one plate is referred to as a cold side plate 103 herein, and the other plate is a hot side plate 105, as referred to herein. Under the Peltier effect, the thermoelectric cooler 102, an electric current causes a transfer of heat to flow from the cold side plate 103 to the hot side plate 105. The cold side plate 103, in the preferred embodiment of the present invention, is adjacent to a wearer 10. The wearer 10, as referred to herein, is an individual using (a user) the present invention. When the heat flows from the wearer 10, a cooling sensation is produced. The thermoelectric cooler 102 comprises an electrical energy supply 116. As shown in FIG. 4, in the electrical energy supply is selected from a battery 116a and an AC/DC input 116b. In an alternative embodiment, the cooling device 100 comprises a plurality of thermoelectric coolers 102, thus increasing the rate of heat transfer.

In the preferred embodiment of the present invention, heat flows from the cold plate to the hot plate and is dissipated into an ambient environment via a blower 114. In an additional embodiment of the present invention, the hot plate comprises a surface, wherein said surface is exposed to the ambient environment. Furthermore, in some embodiments of the present invention, the surface of the hot plate, wherein said surface is exposed to the ambient environment, comprises a plurality of fins 122. The plurality of fins 122 increases the surface area of the hot plate allowing for additional dissipation of heat into the ambient environment. In the preferred embodiment of the present invention, the blower 114 is an electrical fan comprising blades. In the aforementioned embodiment of the present invention, the blades of the fan are configured to expel air heated by the hot plate into the ambient environment surrounding the cooling device 100. In some embodiments of the present invention the blower 114 is configured to operate on direct electrical current parentheses (DC). In an alternative embodiment of the present invention, the blower 114 is configured for bidirectional air flow through the cooling device 100. In some embodiments wherein the blower 114 is configured for bidirectional air flow, the blower 114 is configured to rotate in both counterclockwise and clockwise directions. Furthermore, in some embodiments of the present invention the blower 114 operates under variable speeds to adjust the rate at which heat is dissipated into the ambient environment.

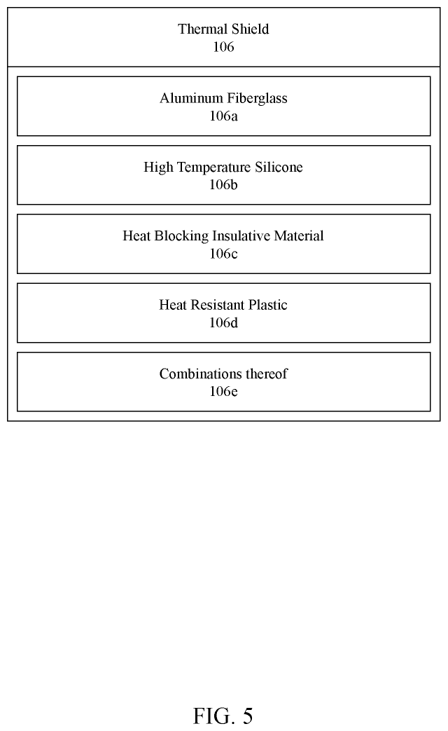

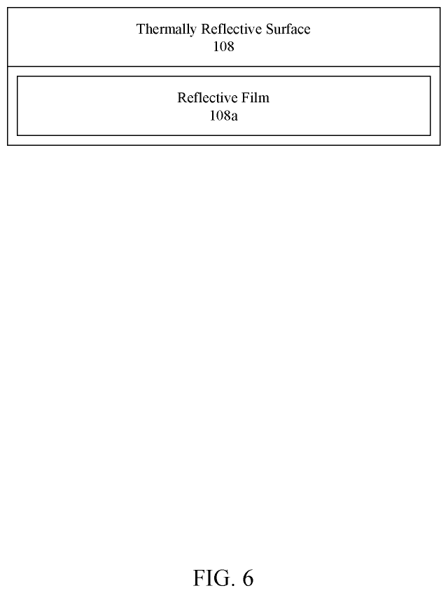

In the preferred embodiment of the present invention, the cooling device 100 further comprises a thermal shield 106. In one embodiment of the present invention, as shown in FIG. 4, the thermal shield 106 is composed of a material such as aluminized fiberglass 106a. Alternatively, as also shown in FIG. 5, in some embodiments of the present invention, the thermal shield 106 is composed of materials selected from a high temperature silicone 106b, a heat blocking insulative material 106c and heat resistant plastic 106d, materials of the like, and combinations thereof 106e. In alternative embodiments of the present invention, the thermal shield 106 comprises an opening. The opening provides space for a portion of the thermoelectric cooler 102, including at least the cold plate, to pass through the thermal shield 106 and contact a thermal conduction sheet 110. In the preferred embodiment of the present invention, the cold plate is removably inserted into the cold pack 112. Additionally, within the preferred embodiment of the present invention, the cold pack is removably coupled interposed between the cold pack 112 and the thermal shield, as shown in FIG. 2. The thermal conduction sheet 110, also referred to as the thermal sheet 110, and some embodiments of the present invention, comprises a thermally reflective surface 108, facing the wearer-side of the garment. In the preferred embodiment of the present invention, the thermal conduction sheet 110 is selected from a material that is rigid or flexible. The thermally reflective surface 108, in some embodiments of the present invention, comprises a reflective film 108a configured to reflect the heat such as aluminate, as shown in FIG. 6.

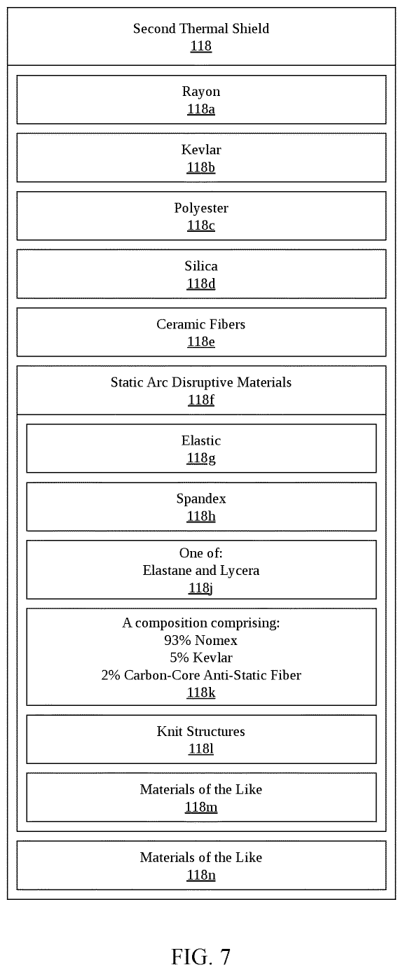

In the preferred embodiment of the present invention, the cooling device 100 further comprises a thermal conduction sheet 110. The thermal conduction sheet 110, in the preferred embodiment of the present invention, is coupled to the cold side 103 of the thermoelectric cooler 102. In some embodiments of the present invention, the thermal conduction sheet 110 is positioned interposed between the thermal shield 106 and the wearer-facing side of the garment. The thermal conduction sheet 110, in some embodiments of the present invention, is used to increase the surface area of the cold side 103, and thus increasing the cooling sensation of the cooling device 100. The thermal conduction sheet 110 is composed of a material having a high thermal conductivity, such as aluminum sheets, including but not limited to flexible aluminum films with an adhesive. Furthermore, the thermal shield 106 may, in some embodiments, comprise aluminized fiberglass. The thermal shield 106 may comprise a layer of thermal insulation 120. The layer of thermal insulation 120 is coupled to the side of the thermal shield 106 opposite the thermally reflective surface 108. In such embodiments, the thermally reflective surface enables reflective cooling. In an alternative embodiment of the present invention, the cooling device 100 comprises a second thermal shield 118. The second thermal shield 118, referred to herein as the supplemental thermal shield 118, is oriented proximate to the hot side plate 105. The supplemental thermal shield 118, in some embodiments of the present invention, comprises a thermally reflective surface 119 facing outwardly from the wearer 10 facing side of the garment. In additional embodiments of the present invention, the supplemental shield may further comprise aluminized fiberglass, similarly to that of the first thermal shield 106. Alternatively, as shown in FIG. 7, in some embodiments of the present invention, the supplemental thermal shield 118 may be composed of a material selected from the list consisting of Rayon 118a, Kevlar 118b, Polyester 118c, silica 118d, ceramic fabrics 118e, and static arc disruptive materials 118f, and materials of the like 118n. In the context of the present invention, the static arc disruptive materials 118f are selected from elastic 118g, spandex 118h, a material selected from elastane and Lycra 118j, knit structures 118l, and materials of the like 118m. Furthermore, in some embodiments of the present invention, the static arc disruptive materials is a composition 118k comprising 95% Nomex, 5% Kevlar, and 2% carbon-core anti-static fiber.

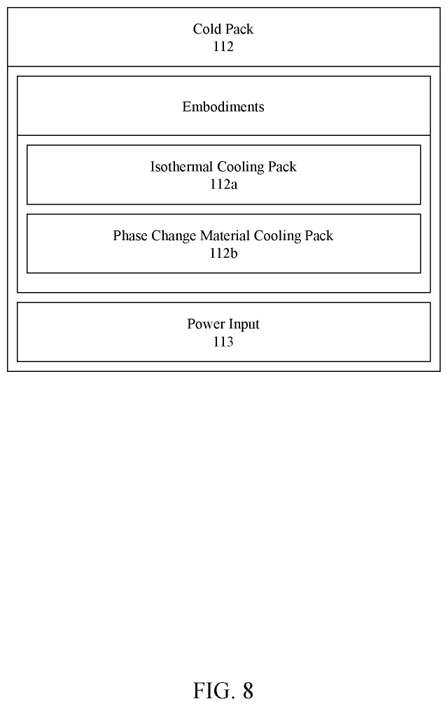

In an alternative embodiment of the present invention, the cooling device 100 comprises a cold pack 112. The cold pack 112 is thermally coupled to a side of the thermal conduction sheet 110 opposite the side of the thermal conduction sheet 110 coupled to the cold side 103 of the thermoelectric cooler 102. In some embodiments of the present invention the cold pack 112 comprises a container with fluid. Additionally, in some embodiments of the present invention, the cold pack 112 is an isothermal cooling pack 112a, as shown in FIG. 8. Alternatively, in some embodiments of the present invention, as further shown in FIG. 8, the cold pack 112 comprises a phase change material cooling pack 112b. In the context of the present invention, phase change material cooling pack 112b is a substance that absorb and release heat to maintain temperatures. Furthermore, in some embodiments of the cold pack 112 comprises a power input 113 such that the power input 113 provides electrically facilitated cooling. The cold pack 112 may be configured to be repetitively accessed, thus removably attached to the garment, for repetitive freezing. In some embodiments, the cold pack 112, is removably coupled to the garment. In some embodiments of the present invention, the cold pack 112 is removably coupled using a hook and loop fastener. In other embodiments of the present invention, the cold pack 112, is coupled to the garment via a button attachment system. Said button system may comprise a snap button clasp system. Additionally, in some embodiments of the present invention, the cold pack is coupled to the garment via a zipper mechanism. Further, a means for coupling the cold pack 112 to the garment, in some embodiments of the present invention, comprises an adhesive. In some embodiments of the present invention, the contents of the cold pack 112 contain a mixture of water, ammonium nitrate, silica gel, or a combination thereof. In some embodiments of the present invention, the cold pack 112 is selected from a group consisting of an ice pack and a temperature changing pack comprising a gel. Although the term “cold pack” has been used in the context of a temperature reducing element, the term “cold pack,” as used herein, shall further be interpreted to refer to a temperature changing pack having capabilities to increase temperature as well.

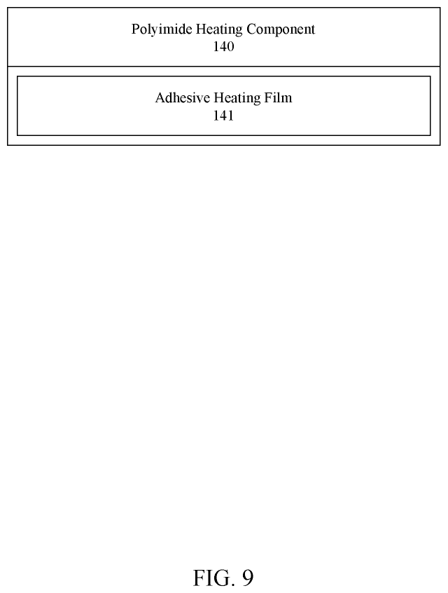

Furthermore, in some embodiments of the present invention, as shown in FIG. 9, the portable cooling device 100, further comprises a polyimide heating component 140. The polyimide heating component 140 is a flexible polyimide heater plate comprising an adhesive heating film 141 interposed between the thermal shield 106 and the thermal conduction sheet 110. In alternative embodiments of the present invention, the polyimide heating component is a flexible polyimide heater plate comprising an adhesive heating film interposed between the thermal shield 106 and the layer of thermal insulation 120. In some embodiments, said polyimide heating component requires a voltage of at least seven volts.

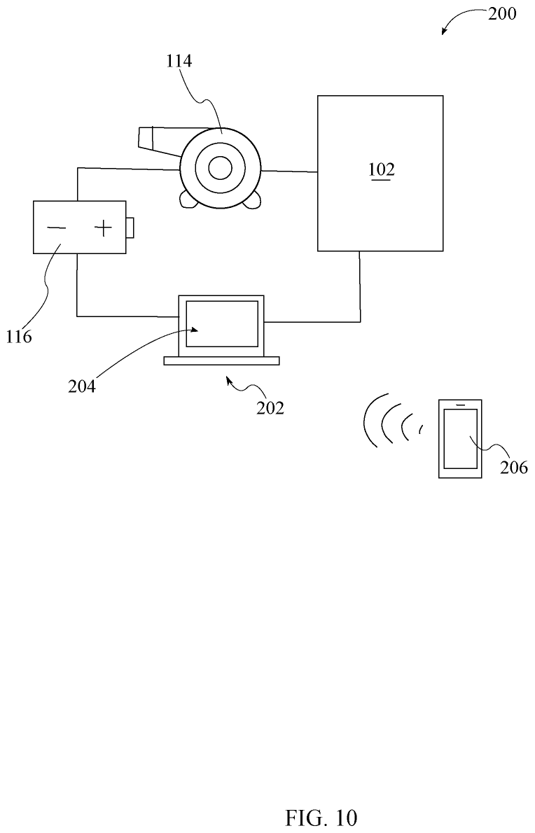

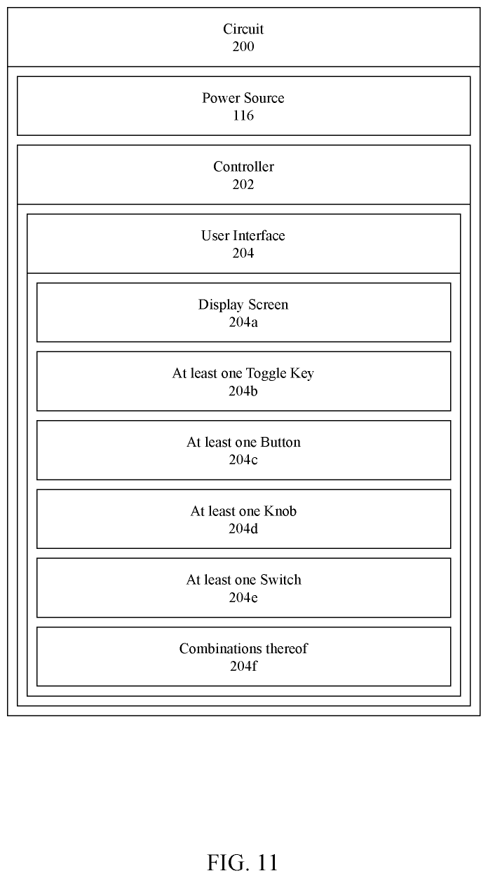

Additionally, in some embodiments of the present invention, the cooling device 100 further comprises a plurality of electrically coupled components in a circuit 200, as shown in FIG. 10 and FIG. 11. In one embodiment of the present invention, the circuit 200 is a direct current (DC) electrical circuit 200. The circuit 200 comprises a power source 116, wherein said power source 116 is a battery 116. In some embodiments, the battery 116 comprises the capacity to be recharged. In some embodiments, the power source 116 is in electrical communication with the blower 114. The circuit 200 further comprises the thermoelectric cooler 102 and a controller 202. The controller 202 being configured to regulate the operation of the circuit 200 via a machine-readable instruction. Furthermore, in alternative embodiments, the circuit 200 comprises a plurality of sensors in communication with each component of the circuit 200 wherein each sensor provides operational data for its respective component to the controller 202. The sensors may include temperature sensors, wherein in some embodiments, the temperature sensors are located on the hot side plate 105, the cold side plate 103, or on the cold pack 112. Data collected by the aforementioned temperature sensors may then be used by the controller 202 to adjust the operation of the thermoelectric cooler 102. In one embodiment, the controller 202 comprises a reverse polarity potentiometer. The reverse polarity potentiometer adjusts the direction of the electrical current, thus said potentiometer is configured to reverse the thermal output of the hot side 105 and the cold side 103 of the thermoelectric cooler 102 in response to a temperature reading from the temperature sensors of the cold side 103 falling below a target temperature.

In further embodiments of the present invention, the controller 202 further comprises a user interface (UI) 204 wherein said UI 204 is a mechanical or graphical user interface. The UI 204 may be used by the wearer 10 to provide user input to the cooling device 100. In some embodiments, as shown in FIG. 11, the UI 204 comprises at least one of the following including a display screen 204a, a plurality or combination of toggle keys 204b, at least one radio button 204c, at least one knob 204d, at least one switch 204e, and combinations thereof 204f. The aforementioned components provide the wearer 10 with the ability to provide inputs as desired. The inputs provided by the wearer 10 are received by the controller 202. Furthermore, in some embodiments of the present invention, the UI 204 may be configured to display operational parameters regarding the circuit 200 comprising a battery life reading, a system temperature, a blower revolutions per minute (rpm), a polarity of the thermoelectric cooler 102, or a combination thereof. In an additional embodiment of the present invention, the controller 202 comprises the capability to identify circuit 200 integrity by using sensors positioned at various components to identify portions of the circuit 200 that are not providing a signal, thus indicating a damaged component. In an additional alternate embodiment of the present invention, the controller 202 may comprise at least one chosen from the group of a receiver and a transmitter, for sending and receiving external signals to the controller 202. In the aforementioned embodiment, the ability to receive and send external signals allows the cooling device 100 to be operated remotely. In one embodiment of the present invention, as shown in FIG. 10, the wearer 10 may use a mobile device 206 via near field communication or far field telecommunication, to interface with an application that communicates with the controller 202 of the cooling device 100. Electrical connections between the components of the circuit 200 are exemplary and the description thereof should not be intended to limit the scope of the present invention.

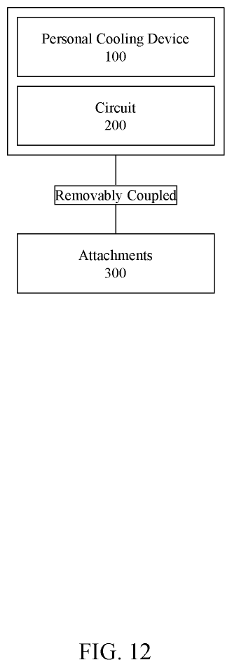

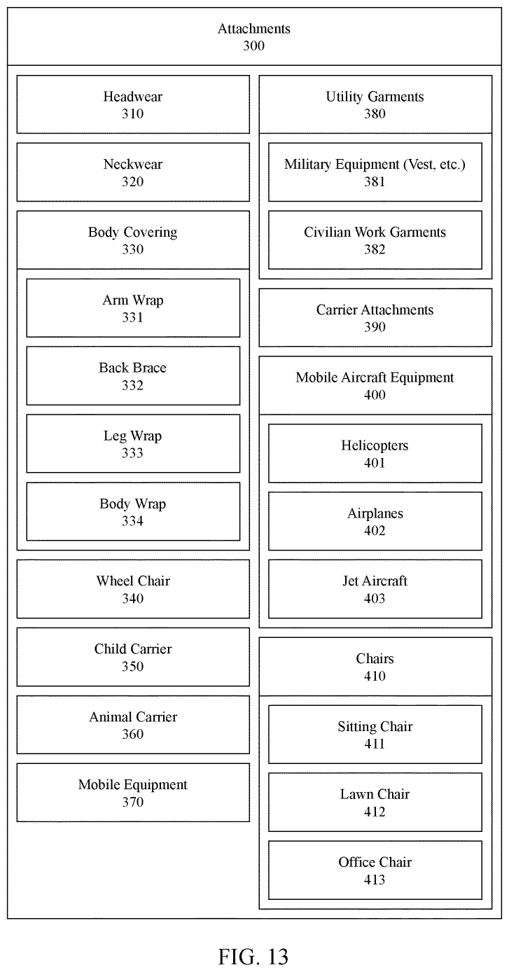

In the preferred embodiment of the present invention, as shown in FIG. 12, the portable cooling device 100 is removably coupled to an attachment 300. In the context of the present invention the attachment 300 is a member, including a garment, in which the portable cooling device 100 is removably coupled to. In the preferred embodiment of the present invention, as shown in FIG. 13, the attachment comprises a headwear 310, a neckwear 320, a body covering 330, a wheel chair 340, a child carrier 350, an animal carrier 360, a mobile equipment 370, a utility garment 380, a carrier attachment 390, a mobile aircraft equipment 400, and a chair 410. In the context of the present invention, the headwear 300, as disclosed herein is a hat, a helmet, a head wrap, and apparatuses of the like wherein said apparatuses cover at least a portion of the user's head. Furthermore, in the preferred embodiment of the present invention, the neckwear 320 is an apparatus which covers at least a portion of the neck, such as a scarf. Additionally, in the preferred embodiment of the present invention, the body covering comprises: an arm wrap 331, including a sleeve; a back brace 332; a leg wrap 333, including a leg sleeve; and a body wrap 334. In the preferred embodiment of the present invention, utility garments 380 comprise a military equipment 381, including a utility/tactical vest, and a civilian work garment 382. Furthermore, in the preferred embodiment of the present invention, the mobile aircraft equipment 400 comprises helicopters 401, airplanes 402, and jet aircraft 403. Furthermore, in the preferred embodiment of the present invention, the chairs 410 comprises a sitting chair 411, a lawn chair 412, and an office chair 413.

In the context of the present invention, a child carrier 350 is a device for carrying an infant or a toddler, including a stroller. Similarly, in the context of the present invention, the animal carrier 360 is a device for carrying an animal.

Although the invention has been explained in relation to its preferred embodiment, it is to be understood that many other possible modifications and variations can be made without departing from the spirit and scope of the invention.

What is claimed is:

1. A portable cooling device comprising:
a cold pack;
a thermoelectric cooler comprising a cold side and a hot side;
a thermal shield comprising an opening therethrough, through which the cold side of the thermoelectric cooler is exposed, wherein the thermal shield has a thermally reflective surface;
the thermal shield being one of:
rayon;
Kevlar;
polyester;
silica;
ceramic fibers;
static arc disruptive materials; and
materials of the like;
a thermal conduction sheet coupled to the cold side of the thermoelectric cooler;
a blower located adjacent the hot side of the thermoelectric cooler configured to blow air across the hot side of the thermoelectric cooler;
a power source configured to power the thermoelectric cooler and the blower.

2. The portable cooling device as claimed in claim 1, wherein the static arc disruptive material is selected from:
elastic;
Spandex;
One of: Elastane and Lycra;
knit structures; and
materials of the like.

3. The portable cooling device as claimed in claim 1, wherein the static arc disruptive material is a composition comprising:
93% Nomex;
5% Kevlar; and
2% carbon-core anti-static fiber.

4. The portable cooling device as claimed in claim 1, wherein the cold pack is removably coupled to a side of the thermal conduction sheet opposite the side of the thermal conduction sheet to the cold side of the thermoelectric cooler; and
wherein the cold pack is selected from an isothermal cooling pack and a phase change material cooling pack.

5. The portable cooling device as claimed in claim 2, further comprising an attachment; wherein:
the portable cooling device is removably coupled to the attachment;
the attachment is selected from:
a headwear;
a neckwear;
a body covering;
a wheel chair;
a child carrier;
an animal carrier;
a utility garment;
a carrier attachment;
a mobile aircraft equipment; and
a chair.

6. The portable cooling device as claimed in claim 1, comprising a supplemental thermal shield, wherein said supplemental thermal shield comprises a second thermally reflective surface.

7. The portable cooling device as claimed in claim 1, wherein the thermal shield comprises a layer of thermal insulation coupled to a side of the thermal shield opposite the thermally reflective surface.

8. The portable cooling device as claimed in claim 1, further comprising a controller configured to control the cooling power of the thermoelectric cooler.

9. The portable cooling device of claim 5, wherein the controller comprises a reverse polarity potentiometer configured to reverse the thermal output of the hot side and the cold side of the thermoelectric cooler in response to a temperature of the cold pack falling below a targeted temperature.

10. The portable cooling device as claimed in claim 7, wherein the controller is coupled to a user interface configured to enable a user to select the targeted temperature;
the user interface selected from one of:
a display screen;
an at least one toggle key;
an at least one button;
an at least one knob; and
an at least one switch.

11. The portable cooling device as claimed in claim 1, wherein the portable cooling device is coupled to a headwear.

12. The portable cooling device as claimed in claim 1, wherein the portable cooling device is coupled to a vest.

13. The portable cooling device as claimed in claim 1, wherein the cold pack is selected from an isothermal cooling pack and a phase change material cooling pack.

14. The portable cooling device as claimed in claim 1, wherein the portable cooling device is coupled to a neckwear.

15. The portable cooling device as claimed in claim 1, wherein the thermal shield comprises an insulative material selected from the group consisting of aluminized fiberglass, high temperature silicone, a heat resistant plastic, materials of the like, and combinations thereof.

16. The portable cooling device as claimed in claim 1, wherein the thermoelectric cooler is a Peltier thermoelectric cooler.

17. The portable cooling device as claimed in claim 1, wherein an external surface of the hot side of the thermoelectric cooler comprises a plurality of fins.

18. A portable cooling device as claimed in claim 7, further comprising a flexible polyimide heater plate comprising an adhesive heating film interposed between the thermal shield and the layer of thermal insulation.

19. A portable cooling device as claimed in claim 7, further comprising a flexible polyimide heater plate comprising an adhesive heating film interposed between the thermal shield and the thermal conduction sheet.

20. The portable cooling device as claimed in claim 4, wherein the cold pack is removably coupled to the garment by a fastener selected from the group consisting of a hook and loop fastener, a zipper, and a button.
